(19) United States
(12) Patent Application Publication
(10) Pub. No.: US 2013/0058707 A1
(43) Pub. Date: Mar. 7, 2013

(54) MODULAR FURNITURE

(71) Applicant: Tsung-Hsiang WANG, New Taipei City (TW)

(72) Inventor: Tsung-Hsiang WANG, New Taipei City (TW)

(21) Appl. No.: 13/598,970

(22) Filed: Aug. 30, 2012

(30) Foreign Application Priority Data
Sep. 6, 2011 (CN) 201120332534.6

(51) Int. Cl. F16B 12/10

(52) U.S. Cl. 403/205

(57) ABSTRACT

A modular furniture has multiple first furniture parts, multiple second furniture parts and multiple assembling devices. The second furniture parts are respectively connected to the first furniture parts and each has a mounting recess. The assembling devices are respectively mounted between the first furniture parts and the second furniture parts, and each assembling device has a holding kit and an engaging frame. The holding kit is connected to one of the first furniture parts and has a positioning rod and a pushing element. The engaging frame is mounted in the mounting recess of one of the second furniture parts, selectively engages the holding kit and has an engaging panel and two engaging recesses formed in the engaging panel. One of the engaging recesses selectively engages the positioning rod in the annular groove and the other engaging recess selectively engages the engaging rod.

### BACKGROUND OF THE INVENTION

1. Field of the Invention

The present invention relates to a modular furniture, and more particularly to a modular furniture that can be assembled and disassembled conveniently.

2. Description of Related Art

A conventional modular furniture can be assembled by a user, and thus can be first disassembled into multiple furniture parts and shipped to the consumer by a manufacturer or retailer. The consumer can then assemble the furniture parts indoors to form the conventional modular furniture. Therefore, the conventional modular furniture such as a bedframe, a wine cabinet or a bookcase can be transported conveniently and can easily go through the narrow spaces such as stairs and corridors. With the above merit, the modular furniture is quite welcomed by consumers and accounts for a large proportion of the consumer furniture market.

The furniture parts of the conventional modular furniture are assembled with screws or bolts, and this is inconvenient and laborious. In addition, the screws or bolts only can be applied to thin or soft boards such as a bedplate of the bedframe or a clapboard of the bookcase, and cannot be applied to hard stakes such as the supporting legs of the bedframe. Therefore, the conventional modular furniture having the supporting legs such as the bedframe or the wine cabinet has recesses and protrusions formed on the supporting legs to connect the furniture parts with each other.

With reference to FIG. 7, two furniture parts 91, 92 of a conventional modular furniture are connected to each other and are respectively defined as a first furniture part 91 and a second furniture part 92. The first furniture part 91 has a side face and a mortise 93 formed in the side face of the first furniture part 91. The second furniture part 92 has a side face and a tenon 94 formed on and protruding from the side face of the second furniture part 92. The tenon 94 is tightly mounted in the mortise 93 to connect the second furniture part 92 with the first furniture part 91.

However, the conventional modular furniture is made of wood and the wood has water-swelling characteristics. Then, the sizes of the mortise 93 and the tenon 94 may be changed after a period of time. When the user wants to assemble the furniture parts 91, 92, the size of the tenon 94 may be larger than the size of the mortise 93 and as a consequence the tenon 94 cannot be mounted into the mortise 93. Then, the user needs to use tools such as a hammer to beat the furniture parts 91, 92 to insert the tenon 94 into the mortise 93 to connect the second furniture part 92 with the first furniture part 91 and this is inconvenient in use. Furthermore, the user needs to use bolt tools to assemble or disassemble the furniture parts 91, 92 and this is inconvenient and takes time and energy in use.

The modular furniture in accordance with the present invention mitigates or obviates the aforementioned problems.

### SUMMARY OF THE INVENTION

The main objective of the present invention is to provide a modular furniture that can be assembled and disassembled conveniently.

The modular furniture in accordance with the present invention has multiple first furniture parts, multiple second furniture parts and multiple assembling devices. The second furniture parts are respectively connected to the first furniture parts and each has a mounting recess. The assembling devices are respectively mounted between the first furniture parts and the second furniture parts, and each assembling device has a holding kit and an engaging frame. The holding kit is connected to one of the first furniture parts and has a positioning rod and a pushing element. The engaging frame is mounted in the mounting recess of one of the second furniture parts, selectively engages the holding kit and has an engaging panel and two engaging recesses formed in the engaging panel. One of the engaging recesses selectively engages the positioning rod in the annular groove and the other engaging recess selectively engages the engaging rod.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a modular furniture in accordance with the present invention;

FIG. 2 is an enlarged and exploded perspective view of the modular furniture in FIG. 1;

FIG. 3 is an enlarged and exploded perspective view of the modular furniture in FIG. 2;

FIG. 4 is an operational side view in partial section of the modular furniture in FIG. 1 in an assembling condition;

FIG. 5 is another operational side view in partial section of the modular furniture in FIG. 1 in an assembling condition;

FIG. 6 is an operational side view in partial section of the modular furniture in FIG. 1 in a disassembling condition; and

FIG. 7 is an exploded perspective view of two furniture parts of a modular furniture in accordance with the prior art.

### DETAILED DESCRIPTION OF PREFERRED EMBODIMENT

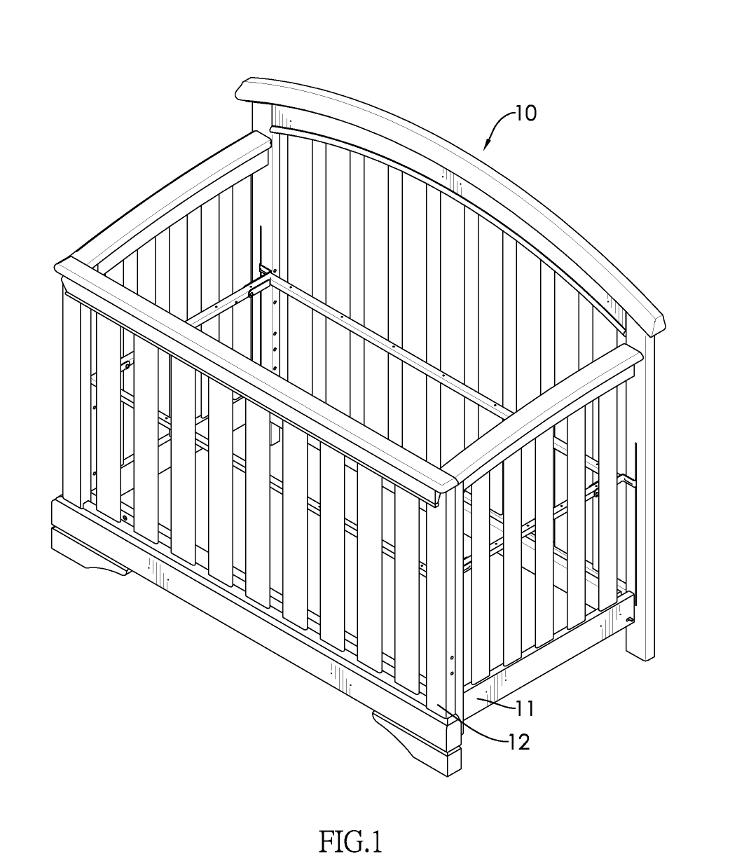

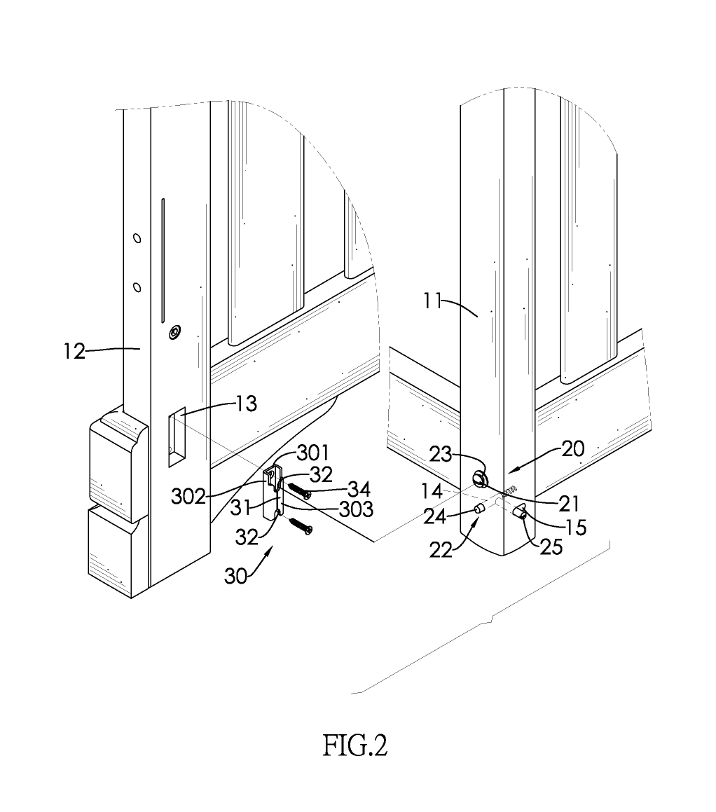

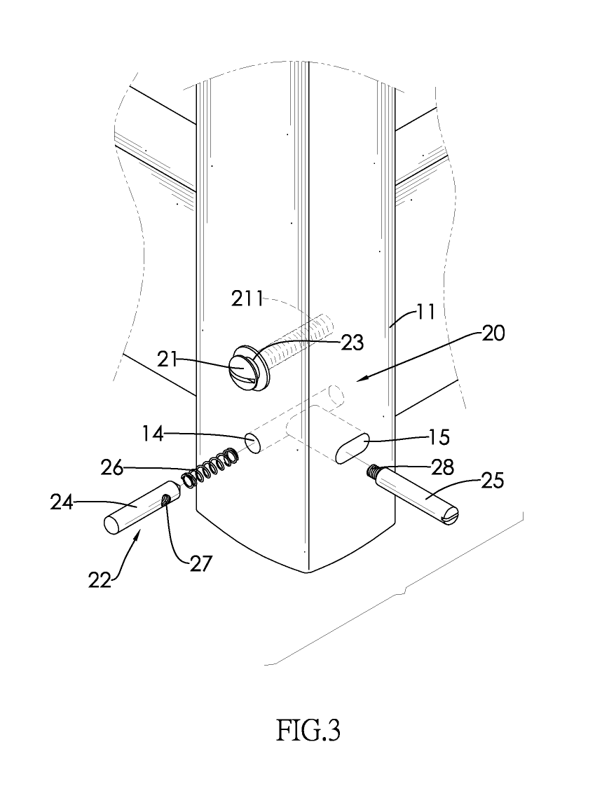

With reference to FIGS. 1 to 3, a modular furniture 10 in accordance with the present invention comprises multiple first furniture parts 11, multiple second furniture parts 12 and multiple assembling devices.

Each furniture part 11 has an outer side, a side face, a mounting hole 14 and a sliding slot 15. The side face is formed with the outer side of the first furniture part 11 at an angle. The mounting hole 14 is formed through the outer side of the first furniture part 11. The sliding slot 15 is formed in the side face of the first furniture part 11, is perpendicular to and communicates with the mounting hole 14.

The second furniture parts 12 are respectively connected to the first furniture parts 11, and each second furniture part 12 has an inner side and a mounting recess 13. The mounting recess 13 is formed in the inner side of the second furniture part 12 and faces the outer side of a corresponding first furniture part 11.

The assembling devices are respectively mounted between the first furniture parts 11 and the second furniture parts 12, and each assembling device has a holding kit 20 and an engaging frame 30.

The holding kit 20 is connected to one of the first furniture parts 11 and has a positioning rod 21 and a pushing element 22.

The positioning rod 21 is mounted in and extends out of the outer side of the corresponding first furniture part 11, is parallel with and above the mounting hole 14 of the corresponding first furniture part 11 and has an inner end, an outer end, an external surface, a bolt 211 and an annular groove 23. The inner end of the positioning rod 21 is mounted in the corresponding first furniture part 11 via the outer side of the first furniture part 11. The outer end of the positioning rod 21 extends out of the outer side of the corresponding first furniture part 11. The bolt 211 is formed on the inner end of the positioning rod 21 and is securely mounted in the corresponding first furniture part 11. The annular groove 23 is formed around the external surface of the positioning rod 21 at the outer end of the positioning rod 21.

The pushing element 22 is movably mounted in the mounting hole 14 and the sliding slot 15 of the corresponding first furniture part 11, and has an engaging rod 24, a pushing shaft 25 and a spring 26. The engaging rod 24 is movably mounted in the mounting hole 14 of the corresponding first furniture part 11 and has an inner end, an outer end, an external surface and a threaded hole 27. The inner end of the engaging rod 24 is movably mounted in the mounting hole 14 of the corresponding first furniture part 11. The outer end of the engaging rod 24 extends out of the mounting hole 14 via the outer side of the corresponding first furniture part 11 below the annular groove 23 of the positioning rod 21. The threaded hole 27 is radially formed in the external surface of the engaging rod 24 near the inner end of the engaging rod 24 and communicates with the sliding slot 15 of the corresponding first furniture part 11.

The pushing shaft 25 is movably mounted in the sliding slot 15 of the corresponding first furniture part 11, is connected to the engaging rod 24 and has an inner end, an outer end and a screwed pin 28. The inner end of the pushing shaft 25 is mounted in the sliding slot 15 of the corresponding first furniture part 11 and extends into the mounting hole 14 of the corresponding first furniture part 11. The outer end of the pushing shaft 25 extends out of the side face of the corresponding first furniture part 11. The screwed pin 28 is axially formed on and protrudes from the inner end of the pushing shaft 25 and is securely mounted in the threaded hole 27 of the engaging rod 24.

The spring 26 is mounted in the mounting hole 14 of the corresponding first furniture part 11 and abuts against the inner end of the engaging rod 24 to enable the outer end of the engaging rod 24 to extend out of the outer side of the corresponding first furniture part 11.

The engaging frame 30 is mounted in the mounting recess 13 of one of the second furniture parts 12, selectively engages the holding kit 20 and has a bottom board 301, two side panels 302, an engaging panel 31, two engaging recesses 32, multiple through holes and multiple fasteners 34. The bottom board 301 is mounted in the mounting recess 13 of the corresponding second furniture part 12 and has two opposite sides. The side panels 302 are respectively formed on and protrude from the opposite sides of the bottom board 301 and face each other.

The engaging panel 31 is formed with the side panels 302, faces the bottom board 301 and the outer side of the corresponding first furniture part 11 and has a top side and a bottom side. Preferably, the engaging panel 31 is formed by two half-engaging panels 303 respectively formed with the side panels 302. The engaging recesses 32 are respectively defined as a first engaging recess 32 and a second engaging recess 32, are respectively formed in the top side and the bottom side of the engaging panel 31. The first engaging recess 32 is formed in the top side of the engaging panel 31 and selectively engages the outer end of the positioning rod 21 in the annular groove 23. The second engaging recess 32 is formed in the bottom side of the engaging panel 31 and selectively engages the outer end of the engaging rod 24. When the engaging recesses 32 of the engaging panel 31 respectively engage the positioning rod 21 and the engaging rod 24, the second furniture part 12 is securely connected with the corresponding first furniture part 11.

The through holes are formed through the bottom board 301 at intervals. The fasteners 34 are respectively mounted through the through holes and are securely mounted in the corresponding second furniture part 12 to securely connect the engaging frame 30 to the corresponding second furniture part 12 in the mounting recess 13.

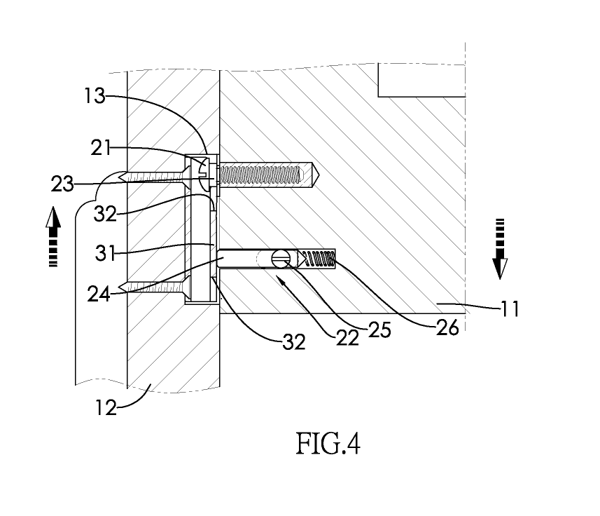

With reference to FIG. 4, in assembling, one of the first furniture parts 11 is connected to an adjacent second furniture part 12, the inner side of the second furniture part 12 abuts and moves relative to the outer side of the first furniture part 11 to enable the outer end of the positioning rod 21 to move into the mounting recess 13 of the second furniture part 12 via the engaging panel 31 of the engaging frame 30. Then, the first engaging recess 32 that is formed in the top side of the engaging panel 31 will aim at the annular groove 23, and the engaging panel 31 will push the engaging rod 24 to move inwardly relative to the mounting hole 14 to press the spring 26 and to enable the pushing shaft 25 to move relative to the sliding slot 15 without aligning with the second engaging recess 32 that is formed in the bottom side of the engaging panel 31. The furniture parts 11, 12 are relatively moved to enable the first engaging recess 32 of the engaging panel 31 to engage the annular groove 23 of the positioning rod 21.

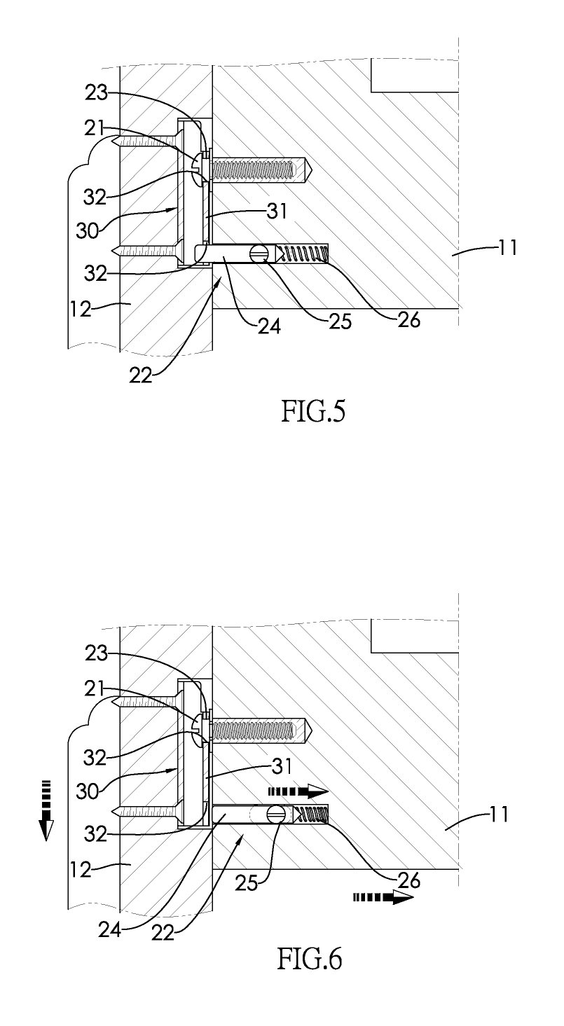

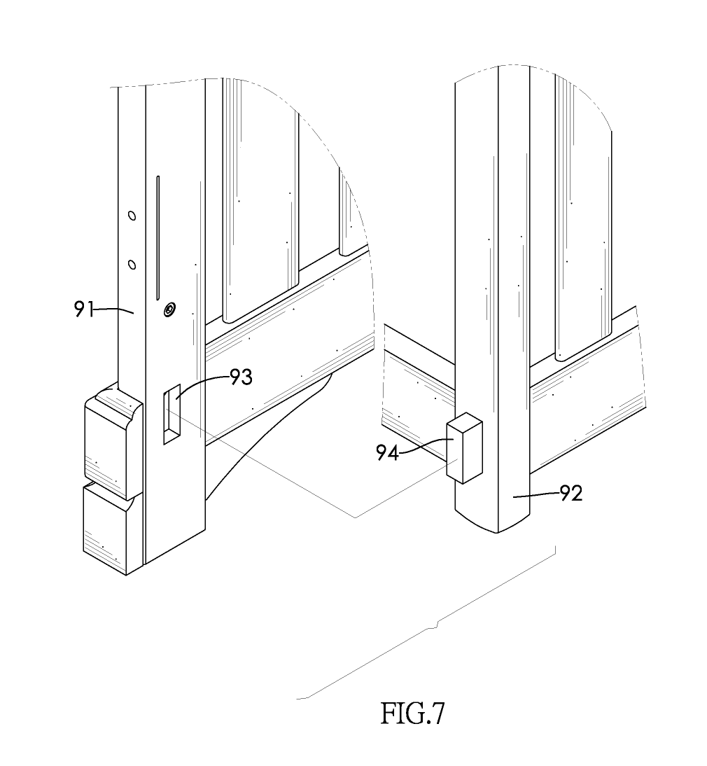

Then, with reference to FIG. 5, when the engaging panel 31 engages the annular groove 23 of the positioning rod 21, the engaging rod 24 is aligned with the second engaging recess 32 and is moved into and engages the second engaging recess 32 by an elastic force of the compressed spring 26. Consequently, the engaging panel 31 is securely connected with the holding kit 20 by the positioning rod 21 and the engaging rod 24. Therefore, the engaging frame 30 that is securely mounted in the mounting recess 13 of the second furniture part 12 can be securely connected to the holding kit 20 that is securely connected to the first furniture part 11 to enable the first furniture part 12 to be securely assembled with the first furniture part 11.

Furthermore, with reference to FIG. 6, to disassemble the furniture parts 11, 12, the engaging rod 24 is moved relative to the mounting hole 14 to disengage from the second engaging recess 32 by pushing the pushing shaft 25 to move along the sliding slot 15. When the engaging rod 24 moves into the mounting hole 14 to compress the spring 26, the first engaging recess 32 can disengage from the annular groove 23 of the positioning rod 21 by moving the second furniture part 12 relative to the first furniture part 11 downward. Then, the second furniture part 12 can be disassembled from the first furniture part 11.

According to the above-mentioned features, the modular furniture in accordance with the present invention does not have the mounting problem of the mortise 93 and the tenon 94 of the conventional modular furniture and, in assembling, a user does not need to beat the furniture parts 11, 12 by tools. Therefore, the modular furniture in accordance with the present invention can be assembled or disassembled easily and conveniently, and can be transported and can go through the stairs and the corridors easily and quickly.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A modular furniture having:
multiple first furniture parts, and each first furniture part having:
an outer side; and
a side face formed with the outer side of the first furniture part at an angle,
multiple second furniture parts respectively connected to the first furniture parts, and each second furniture part having:
an inner side; and
a mounting recess formed in the inner side of the second furniture part and facing the outer side of a corresponding first furniture part; and
multiple assembling devices respectively mounted between the first furniture parts and the second furniture parts, and each assembling device having:
a holding kit connected to a corresponding first furniture part and having:
a positioning rod mounted in and extending out of the outer side of the corresponding first furniture part and having:
an inner end mounted in the corresponding first furniture part via the outer side of the first furniture part;
an outer end extending out of the outer side of the corresponding first furniture part;
an external surface; and
an annular groove formed around the external surface of the positioning rod at the outer end of the positioning rod; and
a pushing element movably mounted in the corresponding first furniture part, paralleling with the positioning rod and having:
an engaging rod movably mounted in the corresponding first furniture part and having:
an inner end movably mounted in the corresponding first furniture part;
an outer end extending out of the outer side of the corresponding first furniture part below the annular groove of the positioning rod; and
an external surface; and
a pushing shaft movably mounted in the corresponding first furniture part, connected to the engaging rod and having:
an inner end; and
an outer end extending out of the side face of the corresponding first furniture part; and
an engaging frame mounted in the mounting recess of one of the second furniture parts that is adjacent to the corresponding first furniture part, selectively engaging the holding kit and having:
an engaging panel mounted in the mounting recess of the corresponding second furniture part, facing the outer side of the corresponding first furniture part and having:
two sides;
a top side; and
a bottom side; and
two engaging recesses respectively defined as a first engaging recess and a second engaging recess, respectively formed in the top side and the bottom side of the engaging panel, the first engaging recess formed in the top side of the engaging panel and selectively engaging the outer end of the positioning rod in the annular groove, and the second engaging recess formed in the bottom side of the engaging panel and selectively engaging the outer end of the engaging rod to connect the corresponding second furniture part with the corresponding first furniture part.

2. The modular furniture as claimed in claim 1, wherein
each first furniture part has
a mounting hole formed through the outer side of the first furniture part; and
a sliding slot formed in the side face of the first modular furniture, being perpendicular to and communicating with the mounting hole of the first furniture part;
the positioning rod of the holding kit of each one of the assembling devices that is mounted in and extends out of the outer side of a corresponding first furniture part is parallel with and above the mounting hole of the corresponding first furniture part;
the engaging rod of the holding kit of each one of the assembling devices is movably mounted in the mounting hole of a corresponding first furniture part and has a threaded hole radially formed in the external surface of the engaging rod near the inner end of the engaging rod and communicating with the sliding slot of the corresponding first furniture part;
the inner end of the pushing shaft of the holding kit of each one of the assembling devices is mounted in the sliding slot of the corresponding first furniture part and extends into the mounting hole of the corresponding first furniture part;
the pushing shaft of the holding kit of each one of the assembling devices is movably mounted in the sliding slot of the corresponding first furniture part and has a screwed pin axially formed on and protruding from the inner end of the pushing shaft and securely mounted in the threaded hole of the engaging rod of the corresponding holding kit; and
the pushing element of the holding kit of each one of the assembling devices has a spring mounted in the mounting hole of the corresponding first furniture part and abutting against the inner end of the engaging rod to enable the outer end of the engaging rod to extend out of the outer side of the corresponding first furniture part.

3. The modular furniture as claimed in claim 2, wherein
the engaging frame of each one of the assembling devices has
two side panels respectively formed on and protruding from the sides of the engaging panel and facing each other;
a bottom board mounted in the mounting recess of a corresponding second furniture part, facing the engaging panel and having two opposite sides respectively formed with the side panels;
multiple through holes formed through the bottom board 301 at intervals; and
multiple fasteners respectively mounted through the through holes and securely mounted in the corresponding second furniture part to securely connect the engaging frame to the corresponding second furniture part in the mounting recess; and
the engaging panel of the engaging frame of each one of the assembling devices is formed by two half-engaging panels respectively formed with the side panels.

4. The modular furniture as claimed in claim 1, wherein
the engaging frame of each one of the assembling devices has
two side panels respectively formed on and protruding from the sides of the engaging panel and facing each other;
a bottom board mounted in the mounting recess of a corresponding second furniture part, facing the engaging panel and having two opposite sides respectively formed with the side panels;
multiple through holes formed through the bottom board at intervals; and
multiple fasteners respectively mounted through the through holes and securely mounted in the corresponding second furniture part to securely connect the engaging frame to the corresponding second furniture part in the mounting recess; and
the engaging panel of the engaging frame of each one of the assembling devices is formed by two half-engaging panels respectively formed with the side panels.

5. The modular furniture as claimed in claim 2, wherein the positioning rod of the holding kit of each one of the assembling devices has a bolt formed on the inner end of the positioning rod and securely mounted in one of the first furniture parts.

6. The modular furniture as claimed in claim 1, wherein the positioning rod of the holding kit of each one of the assembling devices has a bolt formed on the inner end of the positioning rod and securely mounted in one of the first furniture parts.

7. The modular furniture as claimed in claim 3, wherein the positioning rod of the holding kit of each one of the assembling devices has a bolt formed on the inner end of the positioning rod and securely mounted in one of the first furniture parts.

8. The modular furniture as claimed in claim 4, wherein the positioning rod of the holding kit of each one of the assembling devices has a bolt formed on the inner end of the positioning rod and securely mounted in one of the first furniture parts.
